(19) United States
(12) Patent Application Publication
(10) Pub. No.: US 2025/0234136 A1
(43) Pub. Date: Jul. 17, 2025

(54) Variable Impedance Speaker Apparatus

(71) Applicant: AFCO, Inc., Memphis, TN (US)

(72) Inventors: Brad Diedrich, Depere, WI (US); Joseph LoMonaco, San Diego, CA (US); Blake Franchini, Germantown, TN (US)

(73) Assignee: AFCO, Inc., Memphis, TN (US)

(21) Appl. No.: 18/410,432

(22) Filed: Jan. 11, 2024

(51) Int. Cl. H04R 9/04; H04R 9/06

(52) U.S. Cl. CPC H04R 9/045; H04R 9/047; H04R 9/06; H04R 2209/041

(57) ABSTRACT

A variable impedance speaker apparatus comprising multiple, selectable impedances and multiple voice coil wires. In some embodiments, the speaker provides three to four different impedances which can be easily selected by inserting a jumper into the desired coil arrangement to configure the voice coil accordingly. In further embodiments, the speaker apparatus comprises multiple voice coil wires wherein each voice coil wire is wound about a voice coil at the same time.

### FIELD OF INVENTION

The embodiments described herein relate to audio speakers and loudspeakers having selectable impedances and multiple voice coil wires.

### BACKGROUND

An audio speaker, or loudspeaker, is an apparatus that converts electrical audio signals into sound which can be heard at a distance. With the proliferation of music, there is a general need for loudspeakers with improved efficiency, sound quality, and a clear output at all frequencies.

An audio speaker's impedance is a measure of the resistance that a speaker presents to an alternating current signal (e.g., audio from an amplifier). Speaker impedance is measured in ohms (Ω) and represents the resistance to the electrical signal. If a speaker has a low impedance then it more efficiently allows the signal (i.e. the music) to pass through the speakers. Speaker impedance ratings vary, but are commonly 4 ohms, 8, ohms, and 16 ohms, and higher powered amplifiers are often rated for a 1 ohm load.

To produce the best sound quality and avoid damaging the amplifier, it is important to match an amplifier with a loudspeaker's impedance and it is often desirable to use the lowest impedance that is acceptable by the amplifier while producing the maximum power. Furthermore, conventional loudspeakers typically only have 1-2 different impedances to choose from. While this conventional approach may be suitable if there are only one or two woofers, this approach often fails to achieve the best impedance for the amplifier if there are three or more woofers (which is a common occurrence). Accordingly, in some situations it is desirable to vary the impedance of the loudspeaker in order to match the specifications of the amplifier, especially if there are three or more woofers.

While some conventional speakers utilize multiple voice coil wires to provide selectable impedances, this traditional approach is often difficult and challenging. For example, in order to make just one voice coil on a speaker, traditionally two layers of wire must be wound all the way down and back up the voice coil (on top of one another) resulting in four layers of wire wound around the voice coil. Similarly, if three voice coil wires are wrapped around a voice coil using the conventional approach of wrapping on top of another, the voice coil has a total of six layers of wire. Accordingly, this traditional wrapping approach results in a heavy, cumbersome, and very inefficient voice coil that does not address the problem that arises when there are three or more woofers.

Conventional approaches have also generally avoided installing the loudspeakers themselves in different parallel, series, and/or series parallel configurations due to the complexity with wiring, installation, and the significant risk for mistakes or other complications.

Accordingly, there is a significant need for a speaker apparatus providing three or more impedances which can be easily selected by the user as needed, while also maintaining the audio quality and speaker tolerance for each impedance selection. There is also a significant need for an improved voice coil which is lighter and much more efficient than conventional approaches. Along with other features and advantages outlined herein, the variable impedance speaker apparatus within the scope of present embodiments meet these and other needs.

### SUMMARY OF EMBODIMENTS

According to multiple embodiments and alternatives, the variable impedance speaker apparatus (sometimes referred to herein as the “speaker” for brevity) comprises three or four selectable impedances which can be selected by inserting a jumper into the desired impedance setting to configure the voice coil. In some embodiments, the speaker has at least three voice coil arrangements in which each voice coil arrangement provides a different impedance value and the voice coil is in communication with each voice coil arrangement.

In further embodiments, the speaker comprises a jumper assembly which is wired to a input terminal (i.e. the power source), a jumper control board, and a voice coil. In addition, the jumper assembly comprises three or four different wire terminals in which each terminal has a different wiring configuration and a different impedance setting (i.e. different voice coil arrangements). In turn, the bottom of each wire terminal defines a receptacle being adapted to receive a jumper that can be moved into one of the three or four different receptacles by the user to select the speaker's impedance. After receiving the jumper in a receptacle, the jumper assembly is in communication with the selected impedance configuration, the jumper control board, the input terminal, and the voice coil, and therefore ready to allow the signal (i.e. the music) to pass through the speakers at the desired (or selected) impedance setting.

According to multiple embodiments and alternatives, each receptacle is further adapted to receive a cover which can be inserted into the respective receptacles that are not receiving a jumper. Upon being received in a receptacle, the covers do not electrically engage the voice coil. Rather, the covers are adapted to keep the wire terminals clean when they are not in use by keeping dust and other debris out of the receptacles and improve the cosmetics of the speaker.

According to multiple embodiments and alternatives, the speaker comprises a voice coil having three coil wires which are wound around a bobbin at the same time (and are not stacked on top of each other). With this configuration, each voice coil wire has the exact same resistance, which would otherwise not be possible in conventional speaker configurations wherein the coil wires are traditionally stacked on top of one another. The configuration of the voice coil wires in present embodiments also permits each impedance setting to stay within the normal tolerance for a typical speaker. In further embodiments, the coil wires may be stacked on top of each other in certain situations as desired (for instance if the woofer needs additional power handling).

Compared to conventional speakers, the voice coil arrangement of the variable impedance speaker apparatus permits the voice coil to be lighter, more efficient, and to have as few layers of wire as possible. As opposed to conventional speakers, which typically only have 1-2 impedances to select, the variable impedance speaker apparatus provides three to four different impedances which can be easily selected by the user by simply inserting the jumper into the desired impedance configuration. The variable impedance speaker apparatus also maintains the sound quality and provides a robust tolerance for each impedance (or resistance) configuration. Accordingly, the variable impedance speaker apparatus provides a number of advantages over conventional speakers, along with other features and advantages disclosed herein.

### BRIEF DESCRIPTION OF THE FIGURES

The drawings and embodiments described herein are illustrative of multiple alternative structures, aspects, and features of the present embodiments, and they are not to be understood as limiting the scope of present embodiments. It will be further understood that the drawing Figures described and provided herein are not to scale, and that the embodiments are not limited to the precise arrangements and instrumentalities shown.

FIG. 1A is a perspective view of a variable impedance speaker apparatus in which a jumper and covers are not attached to the speaker, according to multiple embodiments and alternatives. FIG. 1B is a perspective view of a variable impedance speaker apparatus in which a jumper and covers are attached to the speaker, according to multiple embodiments and alternatives.

FIG. 2A is a bottom, perspective view of a variable impedance speaker apparatus in which a jumper and covers are not attached to the speaker, according to multiple embodiments and alternatives. FIG. 2B is a bottom, perspective view of a variable impedance speaker apparatus in which a jumper and covers are attached to the speaker, according to multiple embodiments and alternatives.

FIG. 3A is a perspective view of a jumper assembly for a variable impedance speaker in which a jumper and covers are not attached to the speaker, according to multiple embodiments and alternatives. FIG. 3B is a bottom, perspective view of a jumper assembly for a variable impedance speaker in which a jumper and covers are not attached to the speaker, according to multiple embodiments and alternatives. FIGS. 3C-3D are rear, perspective views of a jumper assembly for a variable impedance speaker in which a jumper and covers are not connected to the speaker, according to multiple embodiments and alternatives.

FIG. 4A is a circuit diagram of a variable impedance speaker having three selectable impedances, according to multiple embodiments and alternatives. FIGS. 4B-4D are electrical diagrams illustrating the different coil and jumper arrangements of the circuit diagram shown in FIG. 4A, according to multiple embodiments and alternatives.

FIG. 5 is a circuit diagram of a variable impedance speaker having four selectable impedances, according to multiple embodiments and alternatives.

FIG. 6 is an exploded view of a variable impedance speaker, according to multiple embodiments and alternatives.

FIG. 7A is perspective view of a voice coil, according to multiple embodiments and alternatives. FIG. 7B is a cross-section view of a voice coil, across line 73′-73′ of FIG. 7A, according to multiple embodiments and alternatives.

### MULTIPLE EMBODIMENTS AND ALTERNATIVES

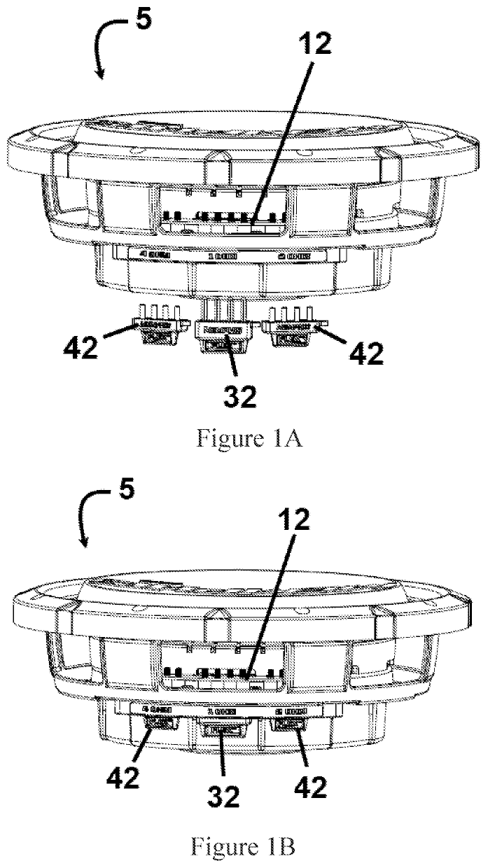

According to multiple embodiments and alternatives, FIGS. 1A-3B illustrate a variable impedance speaker apparatus 5 (also referred to as the “speaker” or “speaker apparatus” for brevity) comprising a jumper assembly 12 with three different selectable impedances and three voice coil wires 52, 53, 54 engaged with a voice coil 71. In further embodiments, the jumper assembly 12 comprises four different selectable impedances and three voice coil wires 52, 53, 54 engaged with a voice coil 71. In further embodiments, the speaker comprises less than three voice coil wires, or at least four voice coils, and the number of pins in the jumper assembly 12 is adjusted accordingly as known to one of ordinary skill in the art.

According to multiple embodiments and alternatives, the voice coil wires 52, 53, and 54 are each wound about a voice coil 71 at the same time (and are not stacked on top of each other). In further embodiments, the voice coil wires may be stacked on top of each if needed or desired. According to multiple embodiments and alternatives, the voice coil wires 52, 53, and 54 are configured to provide the same resistance and in further embodiments, the voice coil wires 52, 53, 54 each different resistances.

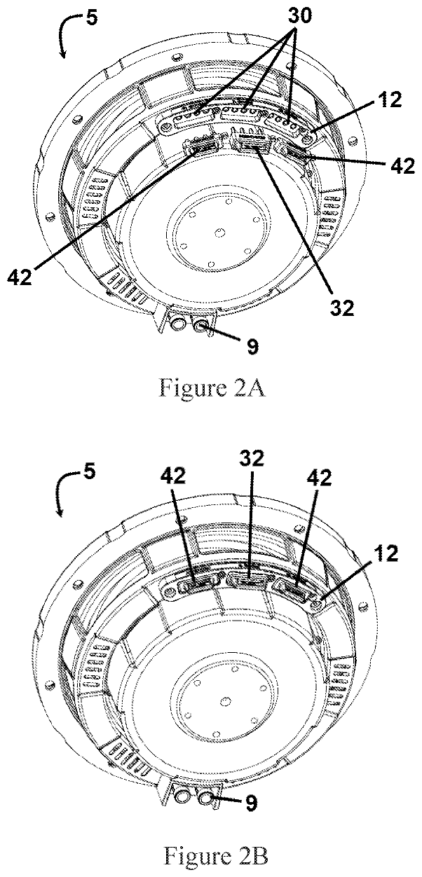

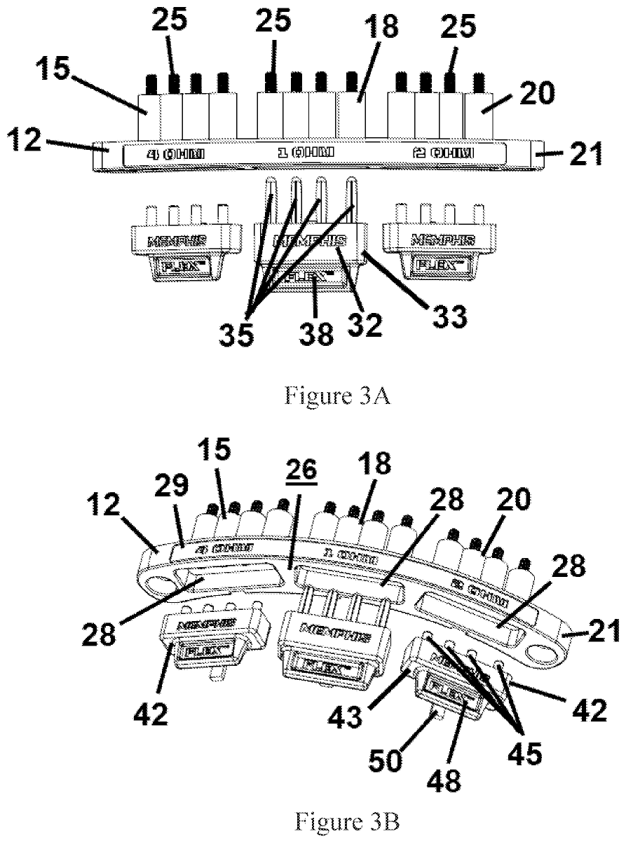

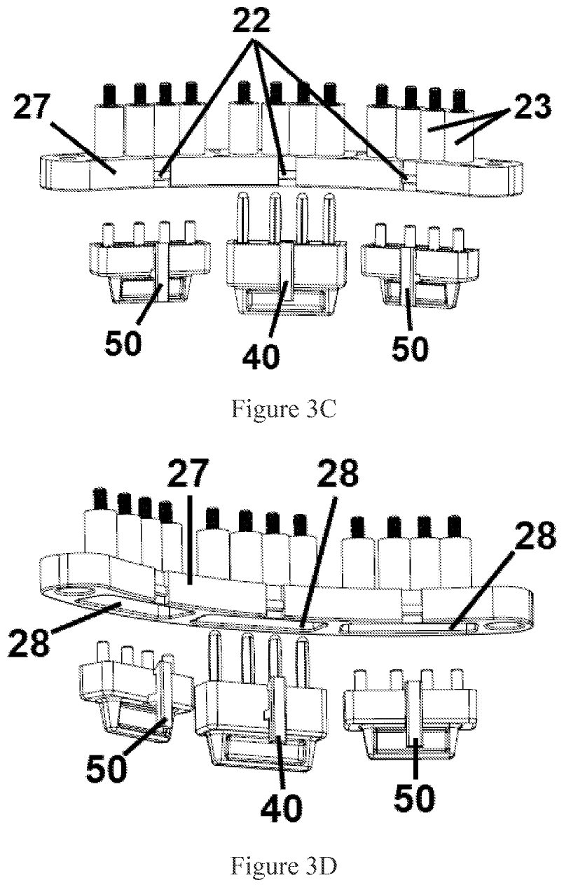

As shown in FIGS. 3A-3D, as a non-limiting example, the jumper assembly 12 includes three different impedance values, such as coil arrangement 15 having a 4Ω impedance value, coil arrangement 18 having a 1Ω impedance value, and coil arrangement 20 having a 2Ω impedance value. As discussed in more detail below, the jumper assembly 12 may also comprise four different coil arrangements each with a different impedance value. Each coil arrangement 15, 18, 20 of the jumper assembly 12 defines a jumper receptacle 28 and borings 30 which are adapted to removably receive a jumper 32 or a cover 42. A user selects the impedance of the speaker 5 by inserting a jumper 32 into the desired jumper receptacle 28 until the extensions 35 (best illustrated in FIG. 3A) are received in the respective borings 30 (best illustrated in FIG. 2A) of the particular impedance configuration. After receiving the jumper 32 in the desired receptacle 28, the jumper assembly 12 is wired to, and in communication with, the selected impedance configuration (i.e. coil arrangement 15, 18, or 20), a jumper control board 7, an input terminal 9 (which provides power to the speaker 5), and a voice coil 71.

In some embodiments, a cover 42 may by inserted into the receptacle 28 of the impedance setting which is not engaged with jumper 32. For example, as shown in FIGS. 1A-2B, the jumper 32 is inserted into the receptacle 28 for coil arrangement 18 (i.e. the 1Ω impedance setting), and therefore the voice coil 71 is providing an impedance of 1Ω. In turn, covers 42 are inserted into the receptacles 28 for coil arrangements 15 and 20, respectively.

As shown in FIGS. 3A-3D, the jumper assembly 12 comprises coil arrangements 15, 18, and 20 (each having different impedance configurations as discussed in detail below). In some embodiments, the jumper assembly 12 further comprises a curved main body 21 having a front 29, a back 27, and a bottom surface 26 defining a series of jumper receptacles 28 directly below the wire terminals 25. Each of the coil arrangements 15, 18, and 20 comprise wire terminals 25 which extend upwards from the main body 21 and cylinders 23 which are wrapped around a bottom portion of the wire terminals 25. The bottom of each of the coil arrangements 15, 18, and 20 define a plurality of borings 30 (best illustrated in FIG. 2A) positioned in the respective receptacle 28 and being are adapted to receive either the extensions 35 of the jumper 32 or the extensions 45 of the cover 42.

FIG. 3A illustrates the jumper 32 having a main body 33 (in which a top portion of the main body 33 is adapted to be received in a receptacle 28), a series of extensions 35 extending upwards from said main body 33, and a finger tab 38 extending downwards from said main body 33. FIG. 3B illustrates the cover 42 having a main body 43 (wherein a top portion of main body 43 is adapted to be received in a receptacle 28), a series of extensions 45 extending upwards from said main body 43, and a finger tab 48 extending downwards from said main body 43.

In some embodiments, the jumper 32 and the covers 42 are removably secured to the jumper assembly 12 via the non-limiting example of snap-clips. For example, as shown in FIGS. 3C-3D, a back of the jumper 32 comprises a snap-clip 40 which is adapted to removably engage one of the clip receivers 22 defined by the back 27 of the jumper assembly 12. Likewise, a back of the covers 42 each comprise a snap-clip 50 which is adapted to removably engage one of the clip receivers 22 defined by the back 27 of the jumper assembly 12. It will be appreciated by one of ordinary skill in the art that the jumper 32 and covers 42 may be connected to the jumper assembly 12 via other connections including the non-limiting example of a screw.

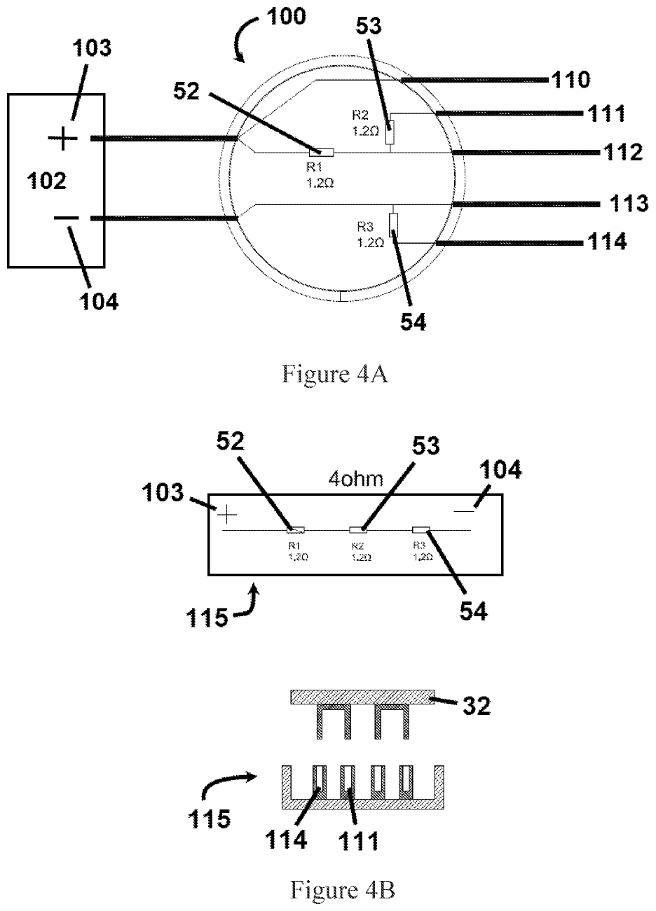

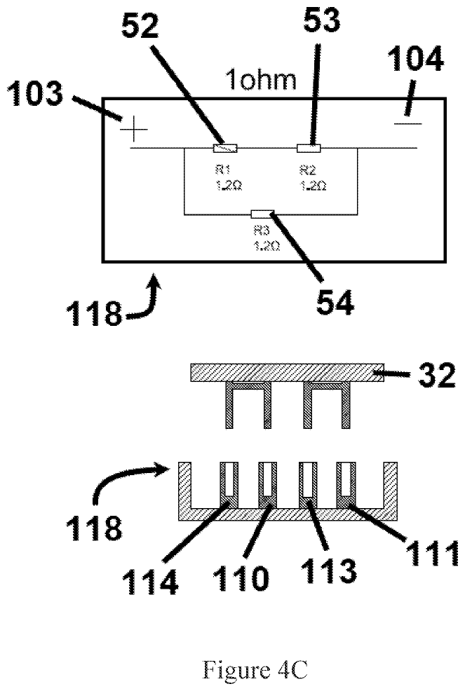

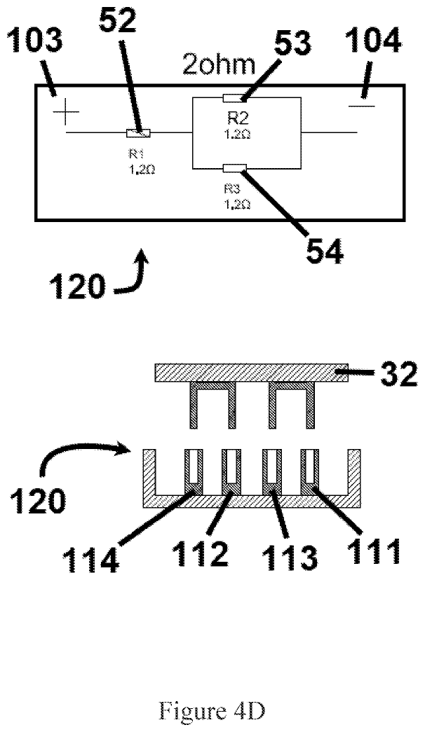

FIGS. 4A-4D are circuit diagrams illustrating a wiring configuration 100 for a speaker 5 having three selectable impedances and three voice coil wires 52, 53, 54 wherein each voice coil wire has the same resistance, such as the non-limiting example of 1.2Ω. In some embodiments, each of the voice coil wires 52, 53, 54 are wrapped around a bobbin 72 of a voice coil 71 at the same (i.e. are not stacked on top of another) which permits each voice coil to have the same resistance. As will be understood by one of ordinary skill in the art, the resistance for the voice coil wires may be selected and varied based on the desired output results and input values. In FIGS. 4A-4D, the resistance of coil wire 52 is represented by the symbol “R1,” the resistance of coil wire 53 is represented by the symbol “R2,” and the resistance of coil wire 54 is represented by the symbol “R3.” The wiring configuration 100 further comprises an input terminal 102 having a positive end 103 and a negative end 104, and wiring pathways 110, 111, 112, 113, and 114.

As illustrated by the electrical diagrams and jumper arrangements in FIGS. 4A-4D, the wiring configuration 100 further comprises the following selectable impedance settings (also referred to as coil arrangements herein): first coil arrangement 115 (4 ohms, also referred to as a first impedance value), second coil arrangement 118, (1 ohm, also referred to as a second impedance value), and third coil arrangement 120 (2 ohms, also referred to as a third impedance value). FIG. 4B illustrates the coil arrangement 115 in which the coil wires 52, 53, 54 are connected in a series circuit, resulting in a net impedance of 4 ohms. In FIG. 4B, the coil arrangement 115 comprises wiring pathways 114 and 111 arranged in said order from one side to the other of the jumper assembly 12 and being adapted to receive jumper 32. Upon receiving and engaging the jumper 32, the coil arrangement 115 provides the user with a net impedance of 4 ohms.

FIG. 4C illustrates coil arrangement 118 in which the coil wires 52, 53, 54 are connected in a series-parallel, resulting in a net impedance of 1 ohm. In FIG. 4C, the coil arrangement 115 comprises wiring pathways 114, 110, 113, and 111 arranged in said order from one side to the other of the jumper assembly 12 and being adapted to receive jumper 32. After receiving the jumper 32, the coil arrangement 118 provides a net impedance of 1 ohm.

FIG. 4D illustrates coil arrangement 120 in which the coil wires 52, 53, 54 are connected in a different series-parallel circuit, resulting in a net impedance of 2 ohms. In FIG. 4D, the coil arrangement 115 comprises wiring pathways 114, 112, 113, and 111 arranged in said order from one side to the other of the jumper assembly 12 and being adapted to receive jumper 32. After a user attaches the jumper 32 to the coil arrangement 120, the net impedance is 2 ohms.

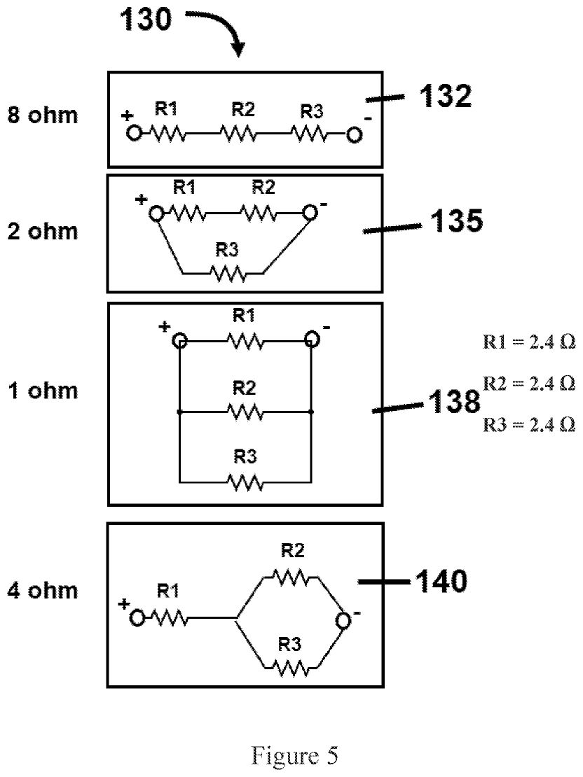

According to multiple embodiments and alternatives, FIG. 5 illustrates the circuit diagrams of a wiring configuration 130 for a speaker 5 having four selectable impedances and three voice coil wires 52, 53, 54, wherein each voice coil wire is wound around a bobbin 72 of a voice coil 71 at the same time and therefore has the same resistance (such as the non-limiting example of 2.4Ω). In FIG. 5, the resistance of coil wire 52 is represented by the symbol “R1,” the resistance of coil wire 53 is represented by the symbol “R2,” and the resistance of coil wire 54 is represented by the symbol “R3.” As shown in FIG. 5, the wiring configuration 130 comprises four selectable impedance settings (or coil arrangements): first coil arrangement 132 (a series circuit having a net impedance of 8 ohms, also referred to as a first impedance value), second coil arrangement 135 (a series and parallel circuit having a net impedance of 2 ohms, also referred to as a second impedance value), third coil arrangement 138 (a parallel circuit having a net impedance of 1 ohm, also referred to as a third impedance value), and fourth coil arrangement 140 (a parallel and series circuit having a net impedance of 4 ohms, also referred to as a fourth impedance value). It will be appreciated by one of ordinary skill in the art that the resistance for the voice coil wires and the impedance (or circuit) configurations may be selected and varied as needed.

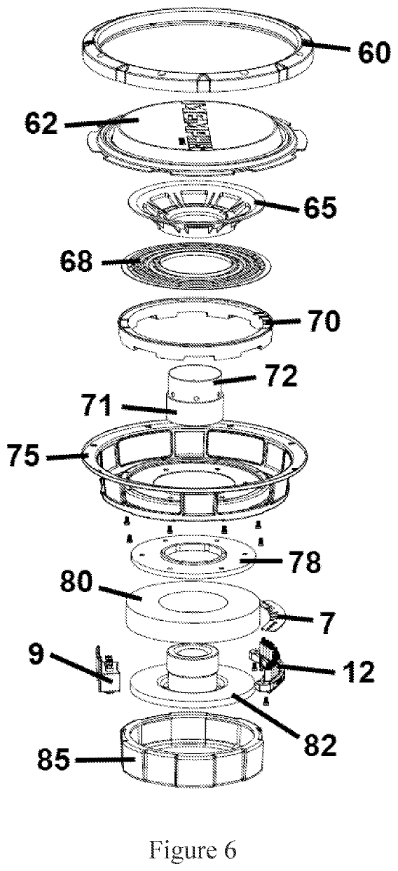

FIG. 6 is an exploded view of the speaker apparatus 5. As shown in FIG. 6, the ring 60 is mounted to the cone assembly 62 which engages a sub-cone support 65. In turn, the sub-cone support 65 is mounted to the spider 68, which engages the spider mounting ring 70. The speaker apparatus 5 further comprises a voice coil 71 having a bobbin 72, wherein the voice coil 71 is received by a basket 75. The bottom of the basket 75 is adapted to receive and engage a front plate 78, a magnet 80, and a t-yoke 82. A bottom cover 85 is then adapted to seal the bottom end of the speaker apparatus 5. The speaker 5 further comprises an input terminal 9 (having a positive and a negative end) which is adapted to provide power to the speaker 5, a jumper assembly 12 having three selectable impedance values, and a jumper control board 7. In further embodiments, the jumper assembly 12 provides four selectable impedance values. According to multiple embodiments and alternatives, the input terminal 9, the jumper assembly 12, the jumper control board 7, and the voice coil 71 are each electrically connected. However, the input terminal 9, the jumper assembly 12, the jumper control board 7, and the voice coil 71 are only in communication with each other after a jumper 32 is received in the respective receptacle 28 of the jumper assembly 12 to configure the voice coil accordingly (i.e. select the desired impedance value).

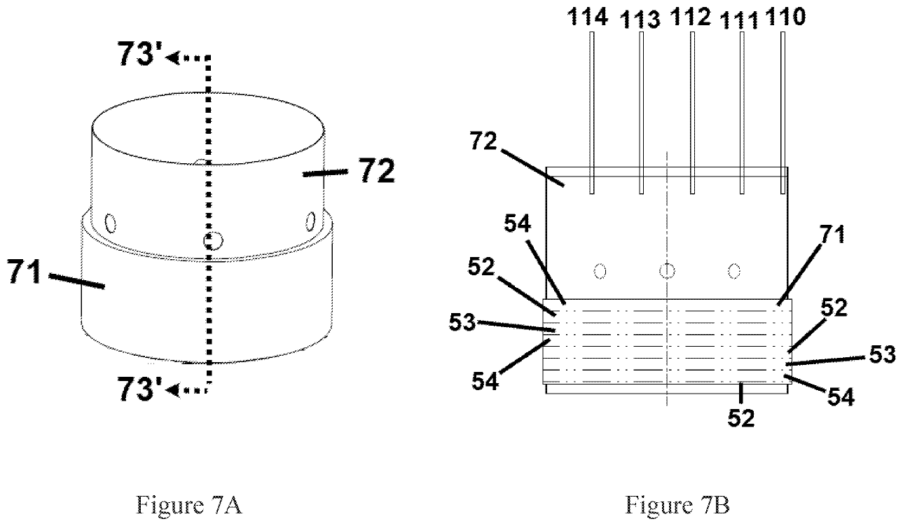

As illustrated in FIGS. 7A-7B, the voice coil 71 comprises a bobbin 72 having a cylindrical shape about which voice coil wires 52, 53, and 54 are wound at the same time (and not stacked upon each other) to form a single layer of coil wire. In other words, the voice coil wires 52, 53, and 54 are each positioned about the perimeter of the bobbin 72 and do not stack upon each other. In some embodiments, the voice coil 71 is wired to the jumper assembly 12 via the wiring pathways 114, 113, 112, 111, and 110 (best illustrated in FIGS. 4A-4D). In further embodiments, the voice coil wires are stacked upon each other as needed or desired.

In operation, the user selects the impedance value of the speaker apparatus 5 by inserting the jumper 32 into the receptacle 28 of the desired impedance setting of jumper assembly 12 to configure the voice coil 71 accordingly. For example, as shown in the non-limiting examples in FIGS. 1A-3D, the user can choose between a 4 ohm, a 1 ohm, or a 2 ohm impedance by inserting the jumper 32 into the desired receptacle 28 of either coil arrangement 15, 18, or 20 until the snap-clip 40 engages the respective clip receiver 22 on the main body 21. Next, the user can insert covers 42 into the other receptacles 28 until the snap-clips 50 engage the corresponding clip receivers 22 on the back 27 of the main body 21. As shown in FIGS. 1B and 2B, once assembled in this manner, the voice coil 71 is configured in the desired impedance setting and the speaker apparatus 5 is ready to allow the signal (i.e. the music) to pass through the speaker.

It will be understood that the embodiments described herein are not limited in their application to the details of the teachings and descriptions set forth, or as illustrated in the accompanying figures. Rather, it will be understood that the present embodiments and alternatives, as described and claimed herein, are capable of being practiced or carried out in various ways.

Also, it is to be understood that words and phrases used herein are for the purpose of description and should not be regarded as limiting. The use herein of “including,” “comprising,” “e.g.,” “containing,” or “having” and variations of those words is meant to encompass the items listed thereafter, and equivalents of those, as well as additional items.

Accordingly, the foregoing descriptions of several embodiments and alternatives are meant to illustrate, rather than to serve as limits on the scope of what has been disclosed herein. The descriptions herein are not intended to be exhaustive, nor are they meant to limit the understanding of the embodiments to the precise forms disclosed. It will be understood by those having ordinary skill in the art that modifications and variations of these embodiments are reasonably possible in light of the above teachings and descriptions.

What is claimed is:

1. A variable impedance speaker apparatus, comprising:
a voice coil having more than one voice coil wire; and
at least three voice coil arrangements;
wherein each voice coil arrangement provides a different impedance value and wherein said voice coil is in communication with the at least three voice coil arrangements.

2. The speaker apparatus of claim 1, wherein the more than one voice coil wire are wound around the voice coil to form a single layer of coil wire.

3. The speaker apparatus of claim 1, further comprising a jumper assembly having said at least three voice coil arrangements; and
wherein each voice coil arrangement is adapted to receive a jumper and to configure the voice coil to the impedance value of said voice coil arrangement upon receiving said jumper.

4. The speaker apparatus of claim 3, further comprising an input terminal and a jumper control board;
wherein upon receiving the jumper each voice coil arrangement is adapted to be in communication with the input terminal, the jumper control board, and the voice coil to permit a signal to pass through said speaker at said impedance value of the particular voice coil arrangement.

5. The speaker apparatus of claim 4, wherein the voice coil comprises three voice coil wires.

6. The speaker apparatus of claim 5, wherein the jumper assembly comprises a first voice coil arrangement in which the voice coil wires provide a first impedance value;
wherein the jumper assembly comprises a second voice coil arrangement in which the voice coil wires provide a second impedance value; and
wherein the jumper assembly comprises a third voice coil arrangement in which the voice coil wires provide a third impedance value.

7. The speaker apparatus of claim 6, wherein the voice coil wires of the first coil arrangement are in series;
wherein the voice coil wires of the second coil arrangement are in series-parallel; and
wherein the voice coil wires of the third coil arrangement are in series-parallel.

8. The speaker apparatus of claim 7, wherein the jumper assembly further comprises a fourth voice coil arrangement in which the voice coil wires are in parallel to provide a fourth impedance value.

9. A variable impedance speaker apparatus, comprising:
a voice coil having more than one voice coil wire wound around said voice coil to form a single layer of coil wire; and
a jumper assembly having at least three voice coil arrangements, wherein each voice coil arrangement provides a different impedance value;
wherein said voice coil is in communication with the jumper assembly.

10. The speaker apparatus of claim 9, wherein the voice coil comprises three voice coil wires.

11. The speaker apparatus of claim 10, wherein the jumper assembly comprises a first voice coil arrangement in which the voice coil wires provide a first impedance value;
wherein the jumper assembly comprises a second voice coil arrangement in which the voice coil wires provide a second impedance value; and
wherein the jumper assembly comprises a third voice coil arrangement in which the voice coil wires provide a third impedance value.

12. The speaker apparatus of claim 11, wherein the voice coil wires of the first coil arrangement are in series;
wherein the voice coil wires of the second coil arrangement are in series-parallel;
wherein the voice coil wires of the third coil arrangement are in series-parallel; and
wherein the jumper assembly further comprises a fourth voice coil arrangement in which the voice coil wires are in parallel to provide a fourth impedance value.

13. The speaker apparatus of claim 11, wherein each voice coil arrangement is adapted to receive a jumper and to configure the voice coil to the impedance value of said voice coil arrangement upon receiving said jumper.

14. The speaker apparatus of claim 13, further comprising an input terminal and a jumper control board;
wherein upon receiving the jumper each voice coil arrangement is adapted to be in communication with the input terminal, the jumper control board, and the voice coil to permit a signal to pass through said speaker at said impedance value of the particular voice coil arrangement.

15. The speaker apparatus of claim 13, wherein each voice coil arrangement is further adapted to receive a cover.

16. A variable impedance speaker apparatus, comprising:
a voice coil having three voice coils wound around said voice coil to form a single layer of coil wire; and
a jumper assembly having a first voice coil arrangement in which the voice coil wires provide a first impedance value, wherein the jumper assembly further comprises a second voice coil arrangement in which the voice coil wires provide a second impedance value, wherein the jumper assembly further comprises a third voice coil arrangement in which the voice coil wires provide a third impedance value.

17. The speaker apparatus of claim 16, wherein the voice coil wires of the first coil arrangement are in series;
wherein the voice coil wires of the second coil arrangement are in series parallel;
wherein the voice coil wires of the third voice coil arrangement are in series parallel; and
wherein the jumper assembly further comprises a fourth voice coil arrangement in which the voice coil wires are in parallel to provide a fourth impedance value.

18. The speaker apparatus of claim 17, wherein each voice coil arrangement is adapted to receive a jumper and to configure the voice coil to the impedance value of said voice coil arrangement upon receiving said jumper.

19. The speaker apparatus of claim 18, further comprising an input terminal and a jumper control board;
wherein upon receiving the jumper each voice coil arrangement is adapted to be in communication with the input terminal, the jumper control board, and the voice coil to permit a signal to pass through said speaker at said impedance value of the particular voice coil arrangement.

20. The speaker apparatus of claim 18, wherein the three voice coils each have the same resistance and each voice coil arrangement is further adapted to receive a cover.
